(19) United States
(12) Patent Application Publication
(10) Pub. No.: US 2005/0066534 A1
(43) Pub. Date: Mar. 31, 2005

(54) Gauge for three-dimensional coordinate measurer

(76) Inventor: Jiro Matsuda, Higashi-ibaraki-gun Ibaraki-ken (JP)

Correspondence Address: BROWDY AND NEIMARK, P.L.L.C.;624 NINTH STREET, NW, SUITE 300, WASHINGTON, DC, 20001-5303, US

(21) Appl. No.: 10/488,182

(22) PCT Filed: May 6, 2003
(86) PCT No.: PCT/JP03/05649

(30) Foreign Application Priority Data
May 9, 2002 (JP) 2002-134114

(51) Int. Cl. G01D 21/00

(52) U.S. Cl. 33/502

(57) ABSTRACT

A gauge (10) for a three-dimensional coordinate measurer fixed onto the measurement table of the three-dimensional coordinate measurer to measure by utilizing the center-to-center distances of spheres and the axis and plane formed of the centers of the plurality of spheres, wherein fitting grooves (2) are formed in the surface of a cylindrical or conical holding body (1) and spherical fixing members (4) having the plurality of spheres (3) arranged thereon are fixedly fitted to the fitting grooves (2), and a standard ring gauge (5) is formed in the holding body (1), whereby three items, that are, scale calibration, straightness, and squareness of the three-dimensional coordinate measurer can be evaluated simultaneously merely by one measurement.

### TECHNICAL FIELD

The present invention relates to a gauge to be used for evaluating performance of a coordinate measuring machine, more specifically to a gauge for three-dimensional coordinate measurer provided with a holder having a cylindrical or conical surface to which a plurality of balls are fixed, for performing quick and simple simultaneous evaluation of calibration, straightness, and orthogonality of a three-dimensional coordinate measurer.

### BACKGROUND ART

A three-dimensional coordinate measurer (CMM) is a measuring machine for performing computer-aided measurement of dimensions and shape utilizing coordinate points of X, Y, and Z discretely located in a three-dimensional space, which, more specifically, is operated in such a manner that an object to be measured placed on a surface plate and a probe attached to a tip of the Z-axis of the measuring machine are relatively moved in three-dimensional directions of X, Y, and Z, and once the probe makes contact with the object to be measured a coordinate value representing the movement along the respective axes is read out according to an electric trigger generated at the instance of contacting, so that a computer calculates dimensions and shape based on the coordinate values. Such three-dimensional coordinate measurer is employed for measuring dimensions of mechanical parts such as a casing for an automobile engine or a transmission gear box, in such a manner that the probe tip is brought into contact with the object to be measured set on a measuring table.

In general, such three-dimensional coordinate measurer is provided with a probe movable in three mutually orthogonal directions. For example, the Japanese Unexamined Patent Publication No. H02-306101 discloses a three-dimensional coordinate measurer provided with a first gantry type movable member linearly movable along horizontal guide rails disposed on both sides of a measuring table on which an object to be measured is set, and the first movable member is provided with a second movable member mounted thereon so as to move in a horizontal direction perpendicular to the moving direction of the first movable member. The second movable member is provided with a vertically movable spindle portion, on a tip of which a probe constituted of a fixed ball is mounted. The probe is moved in three-dimensional directions maintaining the ball in contact with a surface of the object to be measured set on the measuring table, thus to measure the dimensions of each part of the object.

The three-dimensional coordinate measurer of such structure can no longer perform correct measurement when the ball of the probe is worn. Besides, the three-dimensional coordinate measurer may cause a measurement error owing to meandering of the probe tip caused by deflection or distortion of a guide member, such as the guide rails serving to guide the movement of the probe tip, or to angular deviation from correct orthogonality between two guide members for guiding the movement of the probe in two mutually orthogonal directions, etc.

High precision is a particularly important factor of a three-dimensional coordinate measurer, for building up a high-quality production system. For assuring high-precision measurement by a three-dimensional coordinate measurer, regular inspection on the precision is necessary, so that when performing measurement using the three-dimensional coordinate measurer a result of the inspection is reflected as a compensating value in correction of a measured value, or incorporated in an adjusting means for executing micro-adjustment of the three-dimensional coordinate measurer. For executing the precision inspection of the three-dimensional coordinate measurer a reference gauge is required, and the gauge should be capable of evaluating a detected value by moving the probe of the coordinate measuring machine in three-dimensional directions.

Method of evaluating an error of the respective axes has been a serious question to many engineers. Accordingly, gauges specifically designed for evaluating an error of a three-dimensional coordinate measurer have been proposed, all of which are, as known in the industry, basically provided with a coordinate ball for performing the measurement. Now the next step is to determine how to dispose the coordinate ball when constituting a measurement evaluation gauge, and various studies are being carried out on how to dispose the coordinate ball in a plane, including whether to dispose the ball three-dimensionally, and so forth.

For example, the present inventors have proposed a method for evaluating a measurement error in a three-dimensional coordinate measurer and a gauge for three-dimensional coordinate measurer as described in the Japanese Unexamined Patent Publication No. 2001-330428. The proposed gauge is shown in FIGS. 7A to 7D, and this gauge for three-dimensional coordinate measurer 31 has an isosceles-trapezoidal shape in a plan view, and is constituted of a block-shaped holder 32 of a uniform thickness and five pieces each of balls 33 are disposed at regular intervals along the respective lateral oblique surfaces of the holder 32. The respective surfaces of the holder 32 are finished in a high-precision plane, and four through holes 34 are provided in a thicknesswise direction of the holder 32.

When evaluating calibration of a three-dimensional coordinate measurer utilizing such gauge for three-dimensional coordinate measurer 31, the probe is put in contact with four points on the equator and a point on either pole, totally five points of a coordinate ball S1, to thereby geometrically calculate the center position of the ball. Likewise, the respective center positions of a ball S5 on the opposite end of the same row and two balls S6, S10 corresponding to the balls S1, S5 in the opposite row are measured, to define an imaginary reference plane P that includes these ball centers. Then a straight line passing through the respective centers of the balls S1, S10 located at a corresponding end of the mutually confronting rows is defined as A-axis (refer to FIG. 8), and a coordinate system associated with the gauge for three-dimensional coordinate measurer 31, i.e. a gauge coordinate system is defined with its origin set at the midpoint of the A-axis, i.e. the intersection O of the A-axis and a reference line N. The gauge coordinate system is an orthogonal coordinate system with an X-axis set along the direction of the reference axis in the imaginary reference plane and a Y-axis set along the direction of the A-axis, corresponding one-to-one with a machine coordinate system defined in a direction of a machine axis of the three-dimensional coordinate measurer, therefore all coordinate values of the ball centers can be applied to the gauge coordinate system.

After establishing the coordinate at the setting position of the gauge for three-dimensional coordinate measurer 31, the center positions of all the balls are measured in turn, and the center positions of the same balls are measured again in a reverse sequence. The measurement of the center position is executed twice per ball in each turn. Then, the gauge for three-dimensional coordinate measurer 31 is turned over by 180 degrees around the reference axis N and reset on a mounting fixture, and an imaginary reference plane and A-axis are determined in a similar manner to the foregoing steps, to reestablish a gauge coordinate system on the gauge for three-dimensional coordinate measurer 31.

Then the center positions of all the balls are sequentially measured twice in a similar manner to the above, after which the measurement of the center position is similarly executed twice per ball in a reverse sequence.

For evaluating a measurement error of a three-dimensional coordinate measurer, first an error with respect to stable measurement of the balls is evaluated based on measurement results of the ball diameter obtained through the measurement of all the balls and true values of the ball diameters. Then a distance between the ball centers in a direction of the X-axis (reference axis N) and a distance between the ball centers in a direction of the Y-axis (A-axis) are calculated based on values measured with the gauge for three-dimensional coordinate measurer 31 facing upward, and an error is evaluated in comparison with predetermined true values of the distance between the balls. Thereafter, a distance between ball centers in a direction of the A-axis ΔX′ k-1 is calculated based on values measured with the gauge for three-dimensional coordinate measurer 31 turned over by 180 degrees and a distance between the ball centers in a direction of the reference axis N ΔY′ k-1 is calculated based on values measured with the gauge for three-dimensional coordinate measurer 31 facing upward, and then an error is evaluated in comparison with predetermined true values of the distance between the balls. Here, mean values of the measurements obtained with the gauge for three-dimensional coordinate measurer 31 facing upward and turned over by 180 degrees around the reference axis N are adopted for error evaluation, thus to upgrade the precision of the evaluated values.

Then the straightness of machine axes of the three-dimensional coordinate measurer is evaluated. First, for inspecting the straightness of the machine axis installed in a direction of X, δi=(Yi−Y′i)/2 is calculated based on coordinate values Yi of the five balls S1 to S5 measured with the gauge for three-dimensional coordinate measurer 31 facing upward and coordinate values Y′i of the same balls measured with the gauge for three-dimensional coordinate measurer 31 turned over. Straightness in two mutually orthogonal directions is represented by a minimum distance between a pair of planes included in two pairs of geometrically parallel planes, the respective pairs being placed so as to perpendicularly enclose the straight form therebetween, i.e. a minimum length of a longitudinal and a lateral side of a rectangle defined by these pairs of parallel planes. Also, a similar calculation is executed with respect to the five balls S6 to S10, to obtain mean values of the both cases for evaluating the straightness.

Thereafter, orthogonality between two machine axes of the three-dimensional coordinate measurer is evaluated. As shown in FIG. 9, for evaluating orthogonality of a direction of X and a direction of Y at first, an angle θ between the coordinate axis X and a regression line R given through a least squares method from the coordinate values of the five ball centers obtained with the gauge for three-dimensional coordinate measurer 31 facing upside, is calculated. Likewise, an angle θ′ between the coordinate axis X and a regression line R′ similarly given through a least squares method from the coordinate values of the five ball centers obtained with the gauge for three-dimensional coordinate measurer 31 turned over is calculated, and the orthogonality of the three-dimensional coordinate measurer is evaluated according to (θ−θ′)/2. Further, the orthogonality of the remaining five balls S6 to S10 is also evaluated, so that the orthogonality of the axes X and Y of the three-dimensional coordinate measurer is evaluated using the mean value of these orthogonality evaluation results.

The foregoing operation is based on an orientation of the gauge for three-dimensional coordinate measurer 31 as shown in FIG. 7A, however it is also necessary to execute evaluation of straightness of the machine axis in a direction of Y with the gauge for three-dimensional coordinate measurer 31 rotated by 90 degrees in the X-Y plane as shown in FIG. 7B. Further, it is also necessary to set the gauge for three-dimensional coordinate measurer 31 in an upright orientation as shown in FIG. 7C, for evaluation of the deflection of the machine axis Z in a direction of the axis X and the orthogonality between the machine axes Z and X; and to rotate the gauge for three-dimensional coordinate measurer 31 by 90 degrees in the X-Y plane as shown in FIG. 7D, for evaluation of the straightness of the machine axis in the Y-axis direction and the orthogonality between the machine axes Y and Z.

The foregoing gauge for three-dimensional coordinate measurer and the measuring method utilizing the same proposed by the present inventors have enabled a simultaneous and highly precise evaluation of an error in machine axes of a three-dimensional coordinate measurer, which used to be performed in separate operations of scale calibration and of evaluation of geometrical deviation (form deviation, orientational deviation). To perform precise calibration and evaluation with the propose gauge, however, the gauge for three-dimensional coordinate measurer first has to be oriented as shown in FIG. 7A to execute the mentioned measurements, and rotated by 90 degrees in the X-Y plane as shown in FIG. 7B for evaluation of straightness, then set in an upright orientation as shown in FIG. 7C for evaluation of deflection of the machine axis Z in a direction of X and orthogonality between the machine axes Z and X, and further rotated again by 90 degrees in the X-Y plane as shown in FIG. 7D for evaluation of deflection of the machine axis Z in a direction of Y and orthogonality between the machine axes Y and Z, as already described. Accordingly, since the gauge proposed earlier still requires troublesome operations and a lot of time and labor, a gauge for three-dimensional coordinate measurer that permits more effective operation has been sought for.

In view of the foregoing, it is a main object of the present invention to provide a gauge for three-dimensional coordinate measurer that permits quick and easy operation for calibration and evaluation of a three-dimensional coordinate measurer.

### DISCLOSURE OF THE INVENTION

According to the first aspect of the present invention, there is provided a gauge for three-dimensional coordinate measurer comprising a holder having an outer circumferential surface of a rotating object shape formed by rotating a rectilinear generator around its central axis; and at least a pair of coordinate spherical object units including two coordinate spherical object units symmetrically disposed with respect to the central axis of the holder; wherein at least one of the coordinate spherical object units is provided with a plurality of coordinate spherical objects aligned on a straight line.

Here, the other coordinate spherical object unit is provided with at least one coordinate spherical object. In other words, the other coordinate spherical object unit may have just one or a plurality of coordinate spherical objects, provided that the plurality of coordinate spherical objects has to be aligned on a straight line.

Also, the individual spherical objects constituting the coordinate spherical object unit may be mounted either directly onto a coordinate spherical object unit base provided on an outer circumferential surface of the holder, or onto the coordinate spherical object unit base through a coordinate spherical object fixing device as recited in the appended Claim 6.

According to the second aspect of the present invention, there is provided a gauge for three-dimensional coordinate measurer of the first aspect, wherein the rotating object formed by rotating a rectilinear generator around its central axis is a cylindrical object.

According to the third aspect of the present invention, there is provided a gauge for three-dimensional coordinate measurer of the first aspect, wherein the rotating object formed by rotating a rectilinear generator around its central axis is a conical object. Naturally, the conical object includes a truncated conical object.

According to the fourth aspect of the present invention, there is provided a gauge for three-dimensional coordinate measurer of the first aspect, wherein the plurality of coordinate spherical objects in the coordinate spherical object unit are aligned on a straight line that is parallel to the generator of the holder.

According to the fifth aspect of the present invention, there is provided a gauge for three-dimensional coordinate measurer of the first aspect, wherein the plurality of coordinate spherical objects in the coordinate spherical object unit are aligned on a straight line that intersects the generator of the holder.

In other words, the plurality of coordinate spherical objects may be aligned either on a straight line inclined by a predetermined angle from a straight line that is parallel to the generator of the holder, or on a straight line orthogonally intersecting a straight line that is parallel to the generator of the holder.

According to the sixth aspect of the present invention, there is provided a gauge for three-dimensional coordinate measurer of the first aspect, wherein the coordinate spherical object unit is detachably mounted through a coordinate spherical object fixing device onto a coordinate spherical object unit base provided on a surface of the holder.

According to the seventh aspect of the present invention, there is provided a gauge for three-dimensional coordinate measurer of the sixth aspect, wherein the coordinate spherical object unit base is substantially a groove into which the coordinate spherical object fixing device can be inserted.

According to the eighth aspect of the present invention, there is provided a gauge for three-dimensional coordinate measurer of the sixth aspect, wherein the holder is constituted substantially of a magnetic material and the coordinate spherical object fixing device is provided with at least one permanent magnet, so that the coordinate spherical object fixing device can be detachably attached on the holder.

According to the ninth aspect of the present invention, there is provided a gauge for three-dimensional coordinate measurer of the first aspect, wherein the holder is provided with a standard gauge section. A standard ring gauge is preferably employed in the standard gauge section.

According to the tenth aspect of the present invention, there is provided a gauge for three-dimensional coordinate measurer of the first aspect, wherein the holder is provided with at least one supporting projection on an end face thereof. It is preferable to provide three supporting projections on an end face of the holder.

### BRIEF DESCRIPTION OF DRAWINGS

FIGS. 1A to 1C show a gauge for three-dimensional coordinate measurer according to an embodiment of the present invention;

FIG. 1A is a plan view of FIG. 1C viewed from a direction of A-A;

FIG. 1B is a vertical cross-sectional view taken along the line B-B of FIG. 1A;

FIG. 1C is a vertical cross-sectional view taken along the line C-C of FIG. 1A;

FIGS. 2A to 2D show an aspect of the spherical object fixing device;

FIG. 2A is an explanatory drawing of the first aspect;

FIG. 2B is a side view of FIG. 2A;

FIG. 2C is an explanatory drawing of another aspect in which a permanent magnet is attached to the spherical object fixing device;

FIG. 2D is a side view of FIG. 2C;

FIGS. 3A to 3E show a gauge according to another embodiment of the present invention;

FIG. 3A is a plan view of FIG. 3C viewed from a direction of A-A;

FIG. 3B is a vertical cross-sectional view taken along the line B-B of FIG. 3A;

FIG. 3C is a vertical cross-sectional view taken along the line C-C of FIG. 3A;

FIG. 3D is a fragmentary side view of FIG. 3E viewed from a direction of D-D, showing another example of an end face portion of the spherical object fixing device;

FIG. 3E is a reverse plan view of FIG. 3D viewed from a direction of E-E.

FIGS. 4A to 4C show a gauge according to still another embodiment of the present invention;

FIG. 4A is a plan view of FIG. 4B viewed from a direction of A-A;

FIG. 4B is a side view of FIG. 4A viewed from a direction of B-B;

FIG. 4C is a side view of FIG. 4A viewed from a direction of C-C;

FIG. 5 is an explanatory drawing showing the gauge of the present invention placed on a V-block having a V-shaped groove;

FIGS. 6A to 6C show a gauge according to still another embodiment of the present invention;

FIG. 6A is a plan view of FIG. 6B viewed from a direction of A-A;

FIG. 6B is a side view of FIG. 6A viewed from a direction of B-B;

FIG. 6C is a side view of FIG. 6A viewed from a direction of C-C;

FIGS. 7A to 7D are explanatory drawings showing a conventional gauge fixed on a measuring table of a three-dimensional coordinate measurer for performing an operation;

FIG. 8 is an explanatory drawing showing the conventional gauge set on a three-dimensional coordinate measurer; and

FIG. 9 is an explanatory drawing for explaining a method of calculating orthogonality between machine axes utilizing the conventional gauge.

### BEST MODE FOR CARRYING OUT THE INVENTION

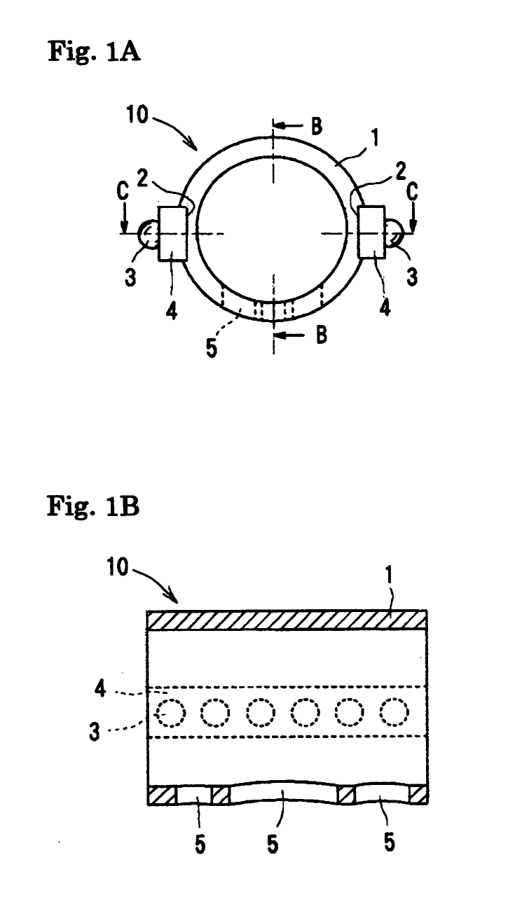

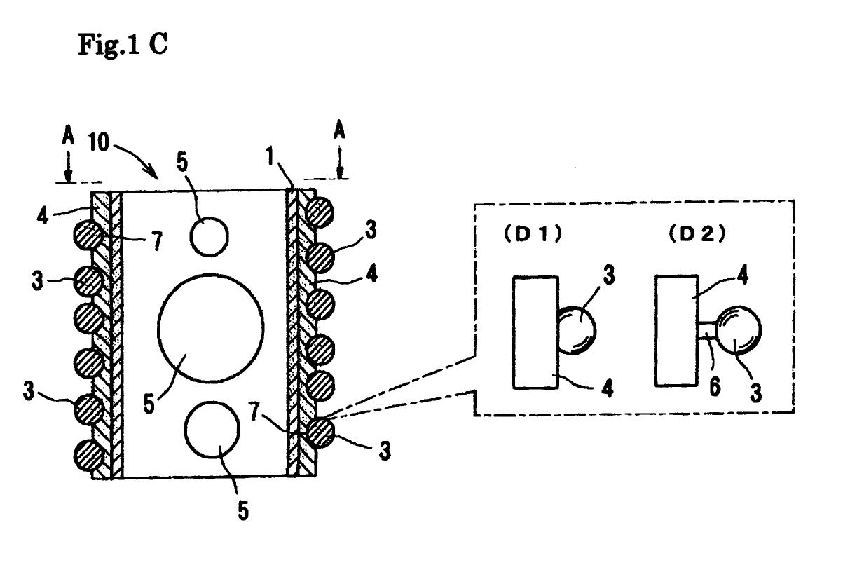

Referring to the drawings, the embodiments of the present invention will be described hereunder. FIGS. 1A to 1C show an embodiment of the present invention. On an outer circumferential surface of a cylindrical holder 1 made of a metal, a coordinate spherical object unit base is provided parallel to the central axis of the cylindrical holder 1, i.e. parallel to the generator of the cylindrical holder, so as to mutually confront with a separation of 180 degrees. In this embodiment the coordinate spherical object unit is provided with six pieces of coordinate spherical objects 3 (hereinafter simply referred to as “spherical object”). The coordinate spherical object unit is mounted onto a coordinate spherical object fixing device 4 (hereinafter simply referred to as “spherical object fixing device”) of a substantially rectangular parallelepiped shape. Also the spherical object fixing device 4 is fixed to a fitting groove 2 serving as the coordinate spherical object unit base, with an adhesive or a screw, etc.

Further, standard gauges of different sizes, in this embodiment, three gauges are provided on an outer circumferential surface of the cylindrical holder 1.

Various methods are available for fixing the spherical object 3 of the coordinate spherical object unit to the spherical object fixing device 4.

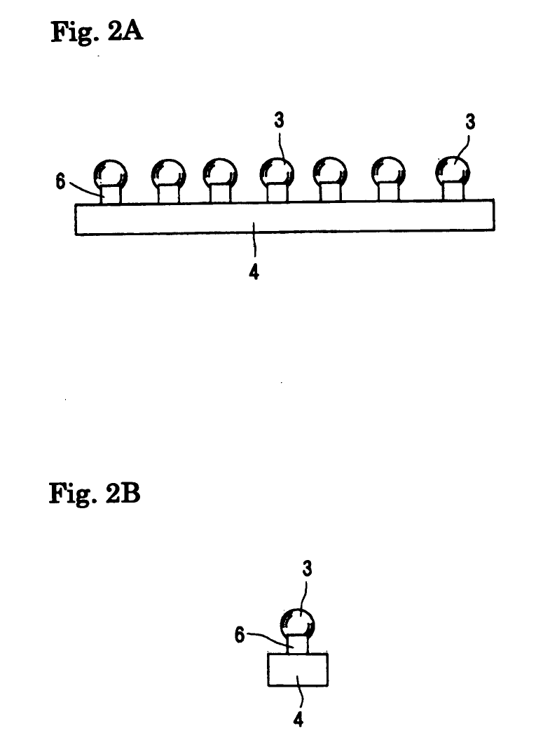

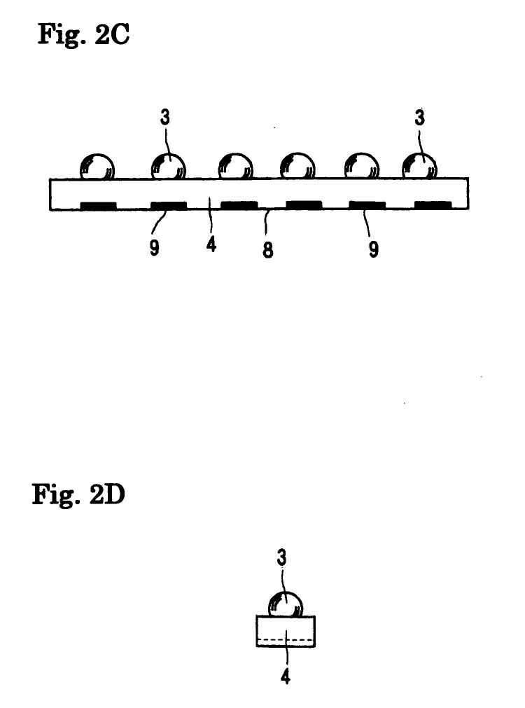

As shown in FIGS. 1A, 1C or D1, which is a fragmentary enlarged view of FIG. 1C, the spherical object can be fixed directly to the spherical object fixing device 4, otherwise it is also possible to fix the spherical object 3 to the spherical object fixing device 4 through a spherical object retainer 6 as shown in FIG. 2D, which is a fragmentary enlarged view of FIG. 1C, FIG. 2A or FIG. 2B.

Further, for fixing the spherical object 3 directly to the spherical object fixing device 4 as shown in FIG. 1C, it is preferable to provide on the spherical object fixing device 4 a spherical fitting recess 7 having a concave curved surface that fits a curved surface of the spherical object 3, so that the spherical object 3 can be fitted into the spherical fitting recess 7 and fixed with an adhesive, etc.

In addition, instead of providing the spherical fitting recess 7 on a surface of the spherical object fixing device 4, it is also preferable to cut off a portion of the spherical object 3 at any chosen plane, and to fix the cut spherical object to a surface of the spherical object fixing device 4. Here, since the semi-spherical object with a portion thereof cut off can perform an equal function to an entire spherical object, such object is also referred to as a “spherical object”.

The spherical object fixing device 4 to which the spherical objects 3 are fixed as above can be built up as shown in FIGS. 2A and 2B, and fitted into the fitting groove 2 provided on the cylindrical holder 1 to be fixed with an adhesive, etc. Alternatively, it is also preferable to attach a permanent magnet 9 on a bottom surface 8 of the spherical object fixing device 4 and to fit such spherical object fixing device into the fitting groove 2 of the cylindrical holder 1, so that the spherical object fixing device 4 is stuck to the cylindrical holder 1 made of a magnetic material such as iron because of the permanent magnet 9. In this way, the spherical object fixing device 4 can be fixed accurately and in an exact position by providing the fitting groove 2 on the cylindrical holder 1.

The above constitution provides another advantage that the cylindrical holder 1 and the spherical object fixing device 4 to which the spherical objects 3 are fixed can be transported separately, therefore the gauge becomes easier to handle. Further, since the spherical object fixing device 4 to which the spherical objects 3 are fixed is a detachable component, the gauge can be easily repaired at a low cost simply by replacing a new spherical object fixing device, when the spherical objects are worn or deformed from a long-term use, or in case where any of the spherical objects are deformed or damaged because of an improper handling, etc.

When evaluating performance of a three-dimensional coordinate measurer utilizing a cylindrical gauge 10 constituted as above, the cylindrical gauge 10 is to be placed in position in one of an X-Y plane, X-Z plane, and a Y-Z plane. When placing the gauge in an X-Y plane it is preferable to provide a V-block as shown in FIG. 5 and to lay the cylindrical gauge 10 on a V-shaped groove on the V-block, by which the cylindrical gauge 10 is stably placed in position.

Upon placing the cylindrical gauge in position, for example a direction of a row of the spherical objects is designated as a direction Y and a direction of a diameter of the cylinder is designated as a direction X, and then the center position of all the six (according to the drawings) spherical objects 3 aligned in one of the rows is measured with a three-dimensional coordinate measurer. As described in details in the foregoing passage regarding the related art, the measurement can be easily executed in a known procedure.

The row of the spherical objects that have been measured is designated as 0 degree side. Then the cylindrical gauge 10 is turned over by 180 degrees and a similar measurement is executed with respect to the spherical objects in the opposite row. Based on these series of measurement data, a distance between centers of the spherical objects is calculated, and the obtained distance is compared with the distance calibrated by a certified national standard, so that scale calibration of the three-dimensional coordinate measurer can be performed according to a comparison result.

Following the above, coordinate data X₀ of a spherical object corresponding to 0 degree and coordinate data X₁₈₀ of the identical spherical object corresponding to 180 degrees i.e. when the gauge is turned over by 180 degrees are processed according to the formula given below:
yᵢ=(X₀−X₁₈₀)/2
wherein i=1 to n (n is a number of spherical objects)

Upon having calculated up to yₙ, evaluation of straightness can be performed according to definition set forth in JIS B 0621.

Also, for evaluating orthogonality, first an angle between a reference line defined by a reference spherical object on the 0 degree side and that on the 180 degree side and a coordinate point of the center of a spherical object that is the farthest from the reference spherical object on the 0 degree side is calculated. Then the gauge is turned over by 180 degrees and similar measurement and calculation is executed, so that the orthogonality can be evaluated by calculating a sum of the both values.

In this way the scale calibration, straightness and orthogonality of the three-dimensional coordinate measurer can be performed at a time through a single session of measurement, therefore such operations can be quite easily performed.

In this embodiment, it is possible to provide a plurality of standard ring gauges 5 (three pieces in this embodiment) on a surface of the cylindrical holder 1 where the spherical object fixing device is not mounted. Accordingly, by measuring these standard ring gauges 5 with the three-dimensional coordinate measurer, a diameter of a circle can be arithmetically calculated based on the discrete data obtained, to make it possible to perform calibration in directions of two axes in a specific plane.

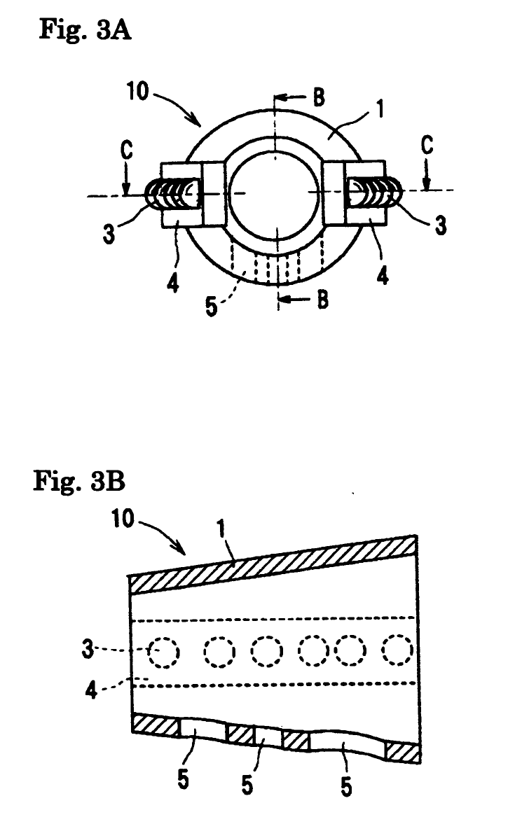

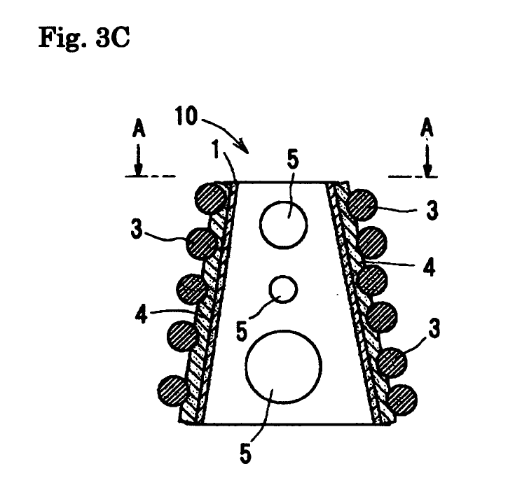

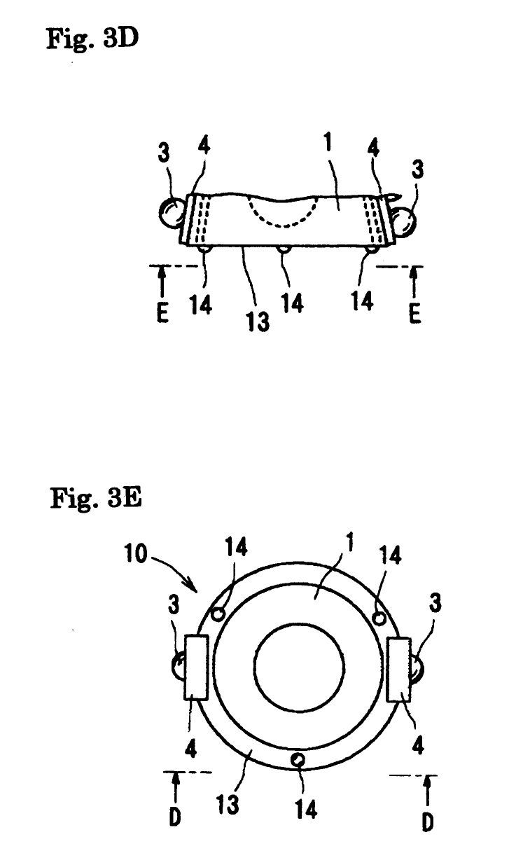

FIGS. 3A to 3C show the holder 1 of the gauge for three-dimensional coordinate measurer according to the present invention formed in a truncated conical shape, for constituting a truncated cone type gauge. Substantial constitution is similar to the foregoing cylindrical gauge, and operation procedure thereof is also similar.

In addition, the spherical objects 3 do not necessarily have to be fitted to the spherical object fixing device 4 to an identical depth, since a difference in fitting depth among the spherical objects 3 does not affect a measurement result. This also applies to the cylindrical gauge.

FIGS. 3D and 3E show still another example, which is provided with supporting projections 14, constituted of three pieces of spherical objects protruding from a bottom face 13 of the truncated conical gauge 10, so as to permit the truncated conical gauge to be placed in position in an upright posture on a measuring table of a three-dimensional coordinate measurer.

Such feature can also be applied to different gauges, including the mentioned cylindrical gauge, etc.

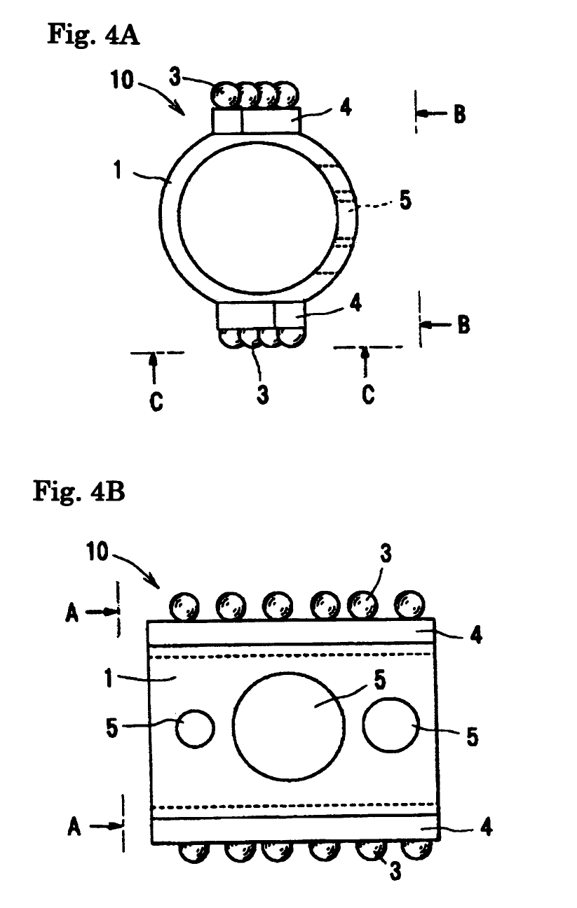

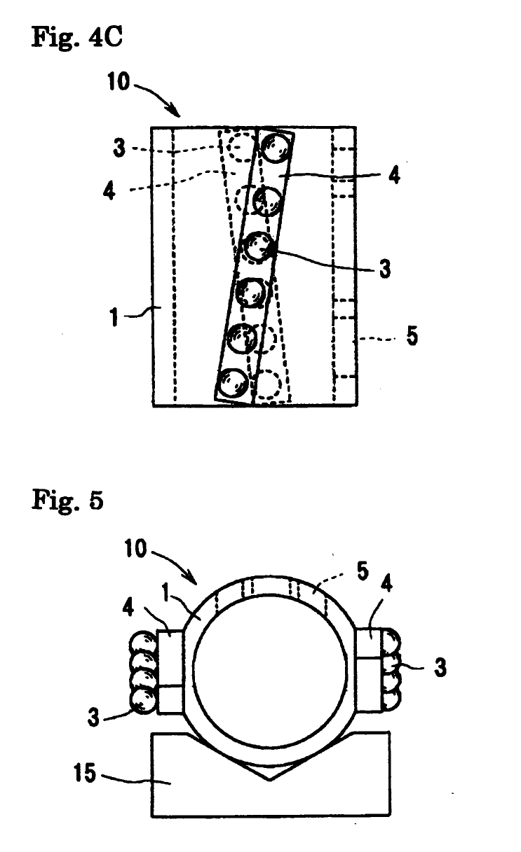

The foregoing embodiment represents an aspect wherein the row of the spherical objects is disposed without distortion with respect to the generator of the cylindrical gauge, while FIGS. 4A to 4C show an aspect wherein the spherical object fixing device 4 is attached with its axial line inclined by a predetermined angle with respect to a straight line that is parallel to the generator of the cylindrical holder 1. In the example shown, the mutually confronting two spherical object fixing devices 4 are inclined in the same direction with respect to the generator of the cylindrical holder 1. Because of such configuration, performance of a three-dimensional coordinate measurer in a space can be more easily evaluated. Further, in this example both of the spherical object fixing devices 4 are inclined, while it is also possible to incline either of the spherical object fixing devices, and a direction of inclination of the respective spherical object fixing devices can be determined in either way as the case may be.

Furthermore it is also possible to attach the spherical object fixing device 4 to a truncated conical gauge as shown in FIGS. 3A to 3C with an inclination with respect to the generator of the truncated conical gauge.

Such gauge is applicable to measurements in an X-Y plane, X-Z plane, and a Y-Z plane. In some calibration steps with a conventional three-dimensional coordinate measurer, a step gauge was placed in position on an inclined table for evaluation of performance in a space, however according to this embodiment the cylindrical gauge is stably placed in a plane, but the spherical object row is attached to the holder with an inclination of various angles. Alternatively the coordinate spherical object can be orthogonally mounted to the generator of the holder. Further, the holder can be placed at a desired height in a direction of its generator, to perform scale calibration in a space as an evaluation of a coordinate space. Through such arrangements, it becomes possible to measure and evaluate the coordinate spherical object with an inclination in a coordinate space. Also since the coordinate spherical object can be placed at a desired position on the holder, scale calibration, straightness, and orthogonality can be evaluated at different heights along the Z-axis. Further since in these series of measurements the center coordinate of the coordinate spherical object unit of the cylindrical gauge can be read out, it is possible to calibrate a scale that is twice as extensive as the coordinate spherical object at maximum, depending on a mounting position of the coordinate spherical object. Consequently, performance over an extensive range can be measured at a time, and scale calibration can be accurately and easily executed.

In addition, FIGS. 4A and 4B show an example in which the spherical objects 3 in the upper row in the drawings are mounted with their substantial portion protruding out of the spherical object fixing device 4, while those in the lower row in the drawings are mounted in such a manner that only approximately a half portion is protruding. Such arrangement is similarly applicable to different gauges.

Further, FIG. 5 shows the cylindrical gauge horizontally sustained, being laid on the V-block 15 provided with a V-shaped groove as illustrated, in which way the cylindrical gauge can be easily and securely fixed. Rotating the gauge sustained on the V-block 15 by a certain angle around the central axis of the holder permits retaining the gauge in different orientations, resulting in easy calibrating operation with a three-dimensional coordinate measurer in various formats.

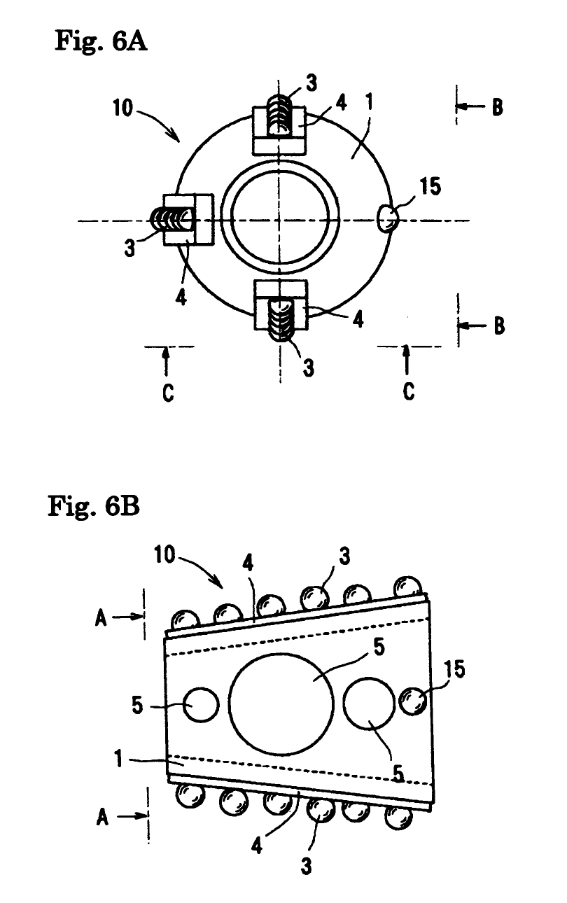

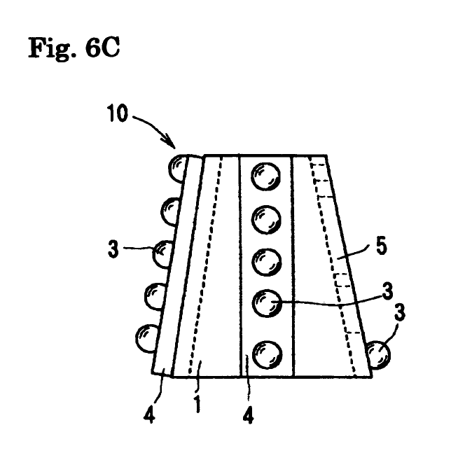

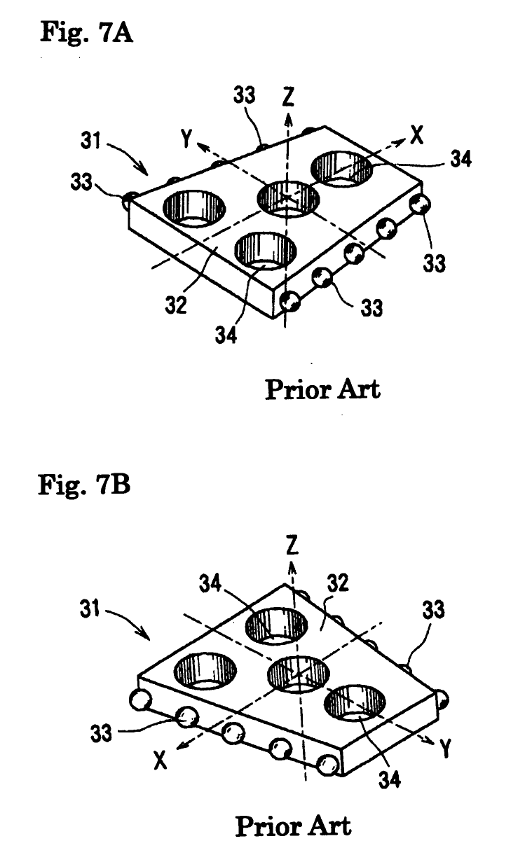

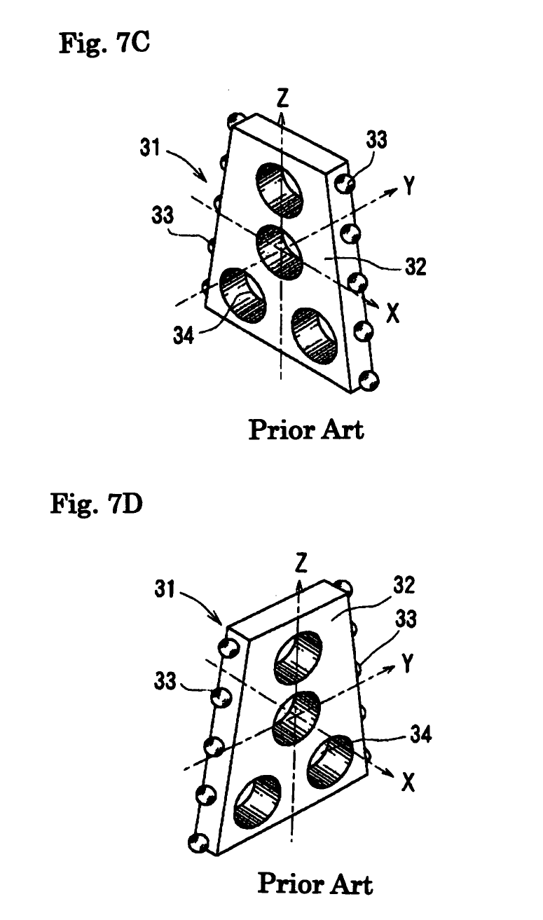

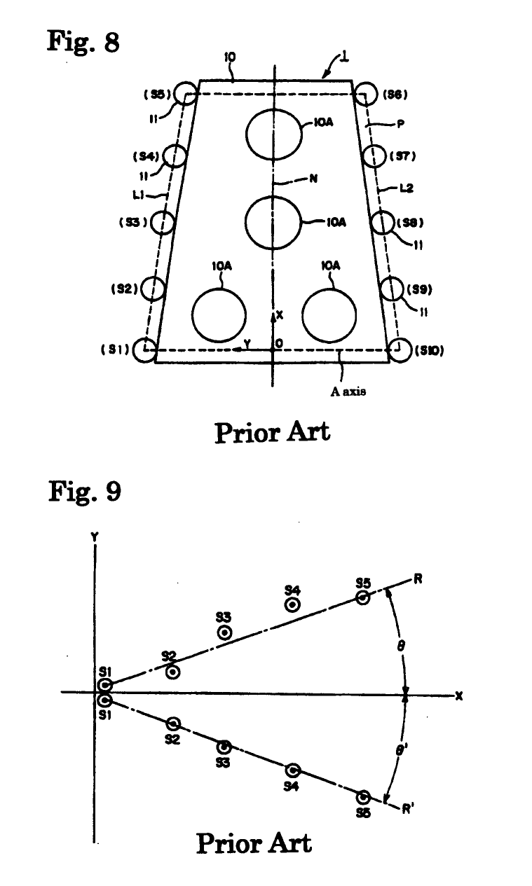

In aspects shown in FIGS. 6A to 6C, the truncated conical holder 1 shown in FIGS. 3A to 3D is employed, on a surface of which three spherical object fixing devices 4 are attached with a separation of 90 degrees between the neighboring ones, and a spherical object 15 is directly fixed to the holder 1 close to an end portion thereof at the remaining point of 90 degrees from the spherical object fixing devices. In other words, this configuration includes two pairs of coordinate spherical object units, namely a pair of coordinate spherical object units both having a plurality of coordinate spherical objects, and another pair of coordinate spherical object units consisting of a coordinate spherical object unit having a plurality of coordinate spherical objects and the other having a single coordinate spherical object.

In addition, the truncated conical holder 1 is provided with three standard ring gauges 5 on its surface extending from the coordinate spherical object unit 15 with a single spherical object is located.

Industrial Applicability

According to the appended Claim 1, the present invention provides a gauge for three-dimensional coordinate measurer comprising a coordinate spherical object unit having a plurality of coordinate spherical objects aligned on a straight line and fixed to an outer circumferential surface of a holder having an outer circumferential surface of a rotating object shape formed by rotating a rectilinear generator around its central axis, therefore calibration and other evaluation of a three-dimensional coordinate measurer can be quickly and easily performed, without need of executing a multiple of times in different orientations as was the case with a conventional plate-shape gauge for a three-dimensional coordinate measurer. Also, executing a measurement with this gauge based on a distance between centers of the spherical objects and an axial line or a plane defined by centers of a plurality of spherical objects permits simultaneous evaluation of the three aspects of scale calibration, straightness, and orthogonality of a three-dimensional coordinate measurer through a single measurement session.

Further, since the gauge for three-dimensional coordinate measurer is provided with a coordinate spherical object unit attached to a surface of a holder having an outer circumferential surface of a rotating object, it is possible to rotate the gauge by a desired angle in addition to 180 degrees when the gauge is laid on its side for example on a block having a V-shaped groove, to thereby execute calibration of a three-dimensional coordinate measurer in various orientations.

Also, since the present invention according to Claim 2 provides the gauge for three-dimensional coordinate measurer as recited in Claim 1, wherein the rotating object formed by rotating a rectilinear generator around its central axis is a cylindrical object, the cylindrical gauge can be securely fixed when laid on a V-block having a V-shaped groove, which further offers the advantage not only that rotating is easy when executing the measurement, but also that deviation of a rotational axial line is minimal, resulting in a minimized measurement error.

Also, since the present invention according to Claim 3 provides the gauge for three-dimensional coordinate measurer as recited in Claim 1, wherein the rotating object formed by rotating a rectilinear generator around its central axis is a conical object, the conical gauge can be securely fixed when laid on a V-block having a V-shaped groove, which further offers the advantage not only that rotating is easy when executing the measurement, but also that when the conical gauge is placed in an X-Y plane a plurality of scale errors on the Y-axis can be measured because the Y-axis also changes with a change of the X-axis.

Also, in case where the respective axes are fixed along the generator of the truncated conical gauge, straightness of a diagonal line in a plane can be obtained according to a cone angle.

Also, since the present invention according to Claim 4 provides the gauge for three-dimensional coordinate measurer as recited in Claim 1, wherein the plurality of coordinate spherical objects in the coordinate spherical object unit are aligned on a straight line that is parallel to the generator of the holder, in case of measuring the coordinate spherical objects with the gauge turned over by 180 degrees the coordinate spherical object unit on the other side is located at the same position, therefore the measuring operation becomes easy and measuring accuracy is improved.

Further, since the present invention according to Claim 5 provides the gauge for three-dimensional coordinate measurer as recited in Claim 1, wherein the plurality of coordinate spherical objects in the coordinate spherical object unit are aligned on a straight line that intersects the generator of the holder, in case of measuring the coordinate spherical objects with the gauge turned over by 180 degrees a plurality of scale errors on the Y-axis can be measured because the Y-axis also changes with a change of the X-axis.

Further, since the present invention according to Claim 6 provides the gauge for three-dimensional coordinate measurer as recited in Claim 1, wherein the coordinate spherical object unit is detachably mounted through a coordinate spherical object fixing device onto a coordinate spherical object unit base provided on a surface of the holder, the holder and the coordinate spherical object unit can be separately transported or stored, therefore the gauge becomes easier to handle. Further, the gauge can be repaired simply by replacing certain components when the gauge is worn or damaged from a long-term use.

Further, since the present invention according to Claim 7 provides the gauge for three-dimensional coordinate measurer as recited in Claim 6, wherein the coordinate spherical object unit base is substantially a groove into which the coordinate spherical object fixing device can be inserted, the spherical object fixing device can be accurately and easily fixed to the holder, besides in a detachable manner if so arranged.

Still further, since the present invention according to Claim 8 provides the gauge for three-dimensional coordinate measurer as recited in Claim 6, wherein the coordinate spherical object fixing device is provided with at least one permanent magnet and is stuck to the holder constituted of a magnetic material, the holder and the spherical objects are separable and therefore transportation, storage, or handling becomes easier.

Still further, since the present invention according to Claim 9 provides the gauge for three-dimensional coordinate measurer as recited in Claim 1, wherein the holder is provided with a standard gauge section, calibration of two axes in a specific plane can be easily performed through an arithmetic processing of a circle diameter based on discrete data obtained by measuring these standard gauges in addition to measuring the spherical objects.

Still further, since the present invention according to Claim 10 provides the gauge for three-dimensional coordinate measurer as recited in Claim 1, wherein the holder is provided with at least one supporting projection on an end face thereof, the gauge can be securely erected on a measuring table.

1. A gauge for three-dimensional coordinate measurer comprising:
a holder having an outer circumferential surface of a rotating object shape formed by rotating a rectilinear generator around its central axis; and
at least a pair of coordinate spherical object units including two coordinate spherical object units symmetrically disposed with respect to the central axis of said holder;
wherein at least one of said coordinate spherical object units is provided with a plurality of coordinate spherical objects aligned on a straight line.

2. The gauge for three-dimensional coordinate measurer as recited in claim 1, wherein said rotating object formed by rotating a rectilinear generator around its central axis is a cylindrical object.

3. The gauge for three-dimensional coordinate measurer as recited in claim 1, wherein said rotating object formed by rotating a rectilinear generator around its central axis is a conical object.

4. The gauge for three-dimensional coordinate measurer as recited in claim 1, wherein said plurality of coordinate spherical objects in said coordinate spherical object unit are aligned on a straight line that is parallel to the generator of said holder.

5. The gauge for three-dimensional coordinate measurer as recited in claim 1, wherein said plurality of coordinate spherical objects in said coordinate spherical object unit are aligned on a straight line that intersects the generator of said holder.

6. The gauge for three-dimensional coordinate measurer as recited in claim 1, wherein said coordinate spherical object unit is detachably mounted through a coordinate spherical object fixing device onto a coordinate spherical object unit base provided on a surface of said holder.

7. The gauge for three-dimensional coordinate measurer as recited in claim 6, wherein said coordinate spherical object unit base is substantially a groove into which said coordinate spherical object fixing device can be inserted.

8. The gauge for three-dimensional coordinate measurer as recited in claim 6, wherein said holder is constituted substantially of a magnetic material; and said coordinate spherical object fixing device is provided with at least one permanent magnet, so that said coordinate spherical object fixing device can be detachably attached to said holder.

9. The gauge for three-dimensional coordinate measurer as recited in claim 1, wherein said holder is provided with a standard gauge section.

10. The gauge for three-dimensional coordinate measurer as recited in claim 1, wherein said holder is provided with at least one supporting projection on an end face thereof.

11. The gauge for three-dimensional coordinate measurer as recited in claim 1, comprising:
a holder having a cylindrical outer circumferential surface;
a pair of coordinate spherical object units including two coordinate spherical object units symmetrically disposed with respect to the central axis of said holder;
wherein said coordinate spherical object units are respectively provided with a plurality of coordinate spherical objects aligned on a straight line that is parallel to the generator of said holder.

12. The gauge for three-dimensional coordinate measurer as recited in claim 1, comprising:
a holder having a cylindrical outer circumferential surface;
a pair of coordinate spherical object units including two coordinate spherical object units symmetrically disposed with respect to the central axis of said holder;
wherein said coordinate spherical object units are respectively provided with a plurality of coordinate spherical objects aligned on a straight line that is inclined by a predetermined angle with respect to the generator of said holder.

13. The gauge for three-dimensional coordinate measurer as recited in claim 1, comprising:
a holder having a conical outer circumferential surface;
a pair of coordinate spherical object units including two coordinate spherical object units symmetrically disposed with respect to the central axis of said holder;
wherein said coordinate spherical object units are respectively provided with a plurality of coordinate spherical objects aligned on a straight line that is parallel to the generator of said holder.
